(19) United States
(12) Patent Application Publication
(10) Pub. No.: US 2009/0075028 A1
(43) Pub. Date: Mar. 19, 2009

(54) Method for producing multi layered coating film

(76) Inventors: Takeshi Suzuki, Osaka (JP); Hirofumi Okamoto, Aichi (JP); Hifumi Egusa, Aichi (JP)

Correspondence Address: WENDEROTH, LIND & PONACK, L.L.P., 2033 K STREET N. W., SUITE 800, WASHINGTON, DC, 20006-1021, US

(21) Appl. No.: 12/230,419

(22) Filed: Aug. 28, 2008

(30) Foreign Application Priority Data
Aug. 28, 2007 (JP) 2007-220946

(51) Int. Cl. B32B 27/40; B05D 3/12

(52) U.S. Cl. 428/172; 428/702; 428/423.1; 427/355

(57) ABSTRACT

A method for producing a multi layered coating film, by applying a base coating composition as defined in the specification on an article to form a base coating; applying a first clear coating composition as defined in the specification on the base coating to form a first clear coating thereon; subjecting both the base coating and the first clear coating thereon to baking and/or curing to form a cured base coating film and a cured first clear coating film thereon; sanding or polishing at least one part of the cured first clear coating film to form a partially sanded or polished first clear coating film; applying a second clear coating composition as defined in the specification all over the first clear coating film to form a second clear coating; and subjecting the second clear coating to baking and/or curing to form a cured second clear coating film.

### TECHNICAL FIELD

The present invention relates to a method for producing a multi layered coating film having an excellent appearance and excellent design properties.

### BACKGROUND OF THE INVENTION

A plurality of coating layers, each of which has an individual role, can be applied on a surface of a substrate such as a body of a vehicle (e.g., an automobile). These coating layers can protect the substrate and provide an appropriate appearance. Generally, a method for forming a multi layered coating film includes steps of applying an under-coating film, such as an electrodeposition coating film, on a substrate having an enough electroconductivity; applying an intermediate coating film thereon; and then applying a top coating film thereon. The top coating film includes a base coating film and a clear coating film. Particularly, the top coating film can significantly influence on the resulting coating appearance and the resulting coating design properties. It is known to those skilled in the art that increase in the number of the applied coating films and/or increase in the number of baking and/or curing steps, and if necessary, presence of sanding or polishing step after the baking or curing step can provide the resulting coating film with a further superior appearance. In the art, three coatings and one baking procedure, wherein one baking step is required to provide a three-layered coating film (3C1B), and three coating and two baking procedure, wherein two baking steps are required to provide a three-layered coating film (3C2B), are well known to those skilled in the art, and therefore employed in order to save energy and financial cost, and in order to achieve good application workability. Recently, a coating appearance in a dark color with an excellent transparency in its depth has been applied to a vehicle body, especially in the field of luxury cars. Accordingly, coating method for providing such coating appearance has been investigated.

Patent literature 1: JP-A-2001-314807 discloses a method for producing a multi layered coating film with an excellent design property. The method includes steps of: (1) applying a first coating composition comprising a coloring agent and/or a luster color pigment, on a surface of an article, in order to form a first coating film; (2) applying a second coating composition comprising a coloring agent thereon, without baking and/or curing the first coating film, in order to form a second coating film thereon; and (3) applying a clear coating composition thereon, without baking and/or curing the second coating film, in order to form a clear coating film thereon, i.e., three coatings and one baking procedure (3C1B). FIG. 1 is a schematic sectional view of the resulting multi layered coating film according to the method described in the patent literature 1. It can be seen from FIG. 1 that the second coating film is a so-called colored clear coating film. The second coating film comprises a coloring agent in an amount within a range of from 0.01 to 1 part by weight relative to solid resin content. The second film is matched in its color with, i.e., similar to, that of the first coating film (i.e., a base coating film). Therefore, this multi layered coating film can provide an excellent transparency in its depth.

According to the method disclosed in the patent literature 1, as shown in FIG. 1, the baking or curing is carried out at once after forming the three layers, i.e., the first coating film, the second coating film and the third coating film in this order. Therefore, the resulting multi layered coating film would often present coating failures such as sagging, popping and decrease in gloss. Consequently, in a dark color, transparency in its depth would be deteriorated. In order to improve the method disclosed in the above-described patent literature 1, it is considered to subject the second coating film to a baking or curing step as shown in FIG. 2. In this case illustrated in FIG. 2, the coating failures in the resulting coating film without such baking or curing step would be decreased. Furthermore, the cured second coating film could be subjected to sanding or polishing step with an abrasive, such as sandpaper, in order to improve wettability to a clear coating composition, i.e., top-coating composition to be applied to form a clear coating film thereon. In this case associated with such sanding or polishing, thickness of the colored clear coating film, i.e., the second coating film would vary, and therefore ununiformity in its color would be observed. Alternatively, light through the clear coating film would be reflected and diffracted on the sanded or polished surface. It could provide a different hue from the original hue. In this case, transparency and color tone of the resulting coating film, in its depth, would disappear.

Patent literature 2: JP-A-2005-305424 corresponding to US 2005/0214483 A1 discloses a method for producing a multi layered coating film with an excellent chromatic property in its depth. This method comprises applying, onto a substrate, base paint (A) containing effect pigment (e.g., luster color pigment), applying onto the resulting base coat, clear paint (B), thereafter hardening the coating film by heating, further applying onto the resulting clear coat, color clear paint (C) containing color pigment and/or dye, and applying onto the resulting color clear coat, top clear paint (D).

The method disclosed in the patent literature 2 is a so-called four coatings and two baking procedure, wherein two baking steps are required to provide a four-layered coating film (4C2B), which can provide an appearance with good in quality and transparency. This method includes increased number of the coating procedures, i.e., four coating procedures. Therefore, the increase in the number of the coating procedures could provide frequent occurrence of the coating failures.

Patent literature 3: JP-A-11-104563 corresponding to U.S. Pat. No. 6,017,589 discloses a process for forming a coating film, wherein the process comprising the steps of (a) coating a substrate with a dark color coating comprising a thermosetting resin composition, a coloring pigment, carbon black pigment, and an interference color pigment, and (b) coating the dark color coat with a color clear coating comprising a thermosetting resin composition and carbon pigment such as carbon black pigment, and if necessary, other coloring pigment.

The method disclosed in the patent literature 3 is a so-called two coatings and one baking procedure, wherein one baking step is required to provide a two-layered coating film (2C1B). The resulting coating film would have an insufficient transparency in its depth and an insufficient color tone in its depth. The coating failures in the resulting coating film could be decreased, since the coating film consists of only two layers. This coating film, however, would not be applicable to a luxury car requiring a dark color with transparency its depth and color tone in its depth.

Patent literature 4: JP-A-H2-131171 discloses a method for producing a multi layered coating film including steps of forming an electrodeposition coating film on an article, and then forming a colored intermediate coating film thereon; if necessary, baking the colored-intermediate coating film; applying a clear coating composition, by wet-on-wet, on the colored-intermediate coating film to provide a clear coating film thereon; baking the clear coating film; applying a top clear coating composition on the baked clear coating film to provide a top clear coating film with a low hiding ability. This method includes formation of two clear coating layers on the colored intermediate coating film. The colored intermediate coating film, however, does not contain any luster color pigments. Therefore, hue and quality of the resulting coating film are different from those required in a luxury car.

Patent Literature 1: JP-A-2001-314807

Patent Literature 2: JP-A-2005-305424

(corresponding to US 2005/0214483 A1)

Patent Literature 3: JP-A-H11-104563

(corresponding to U.S. Pat. No. 6,017,589)

Patent Literature 4: JP-A-H2-131171

### SUMMARY OF THE INVENTION

### Disclosure of the Invention

### Problem to be Solved by the Invention

Object of the present invention consists in a provision of a convenient coating method for producing a multi layered coating film, in a dark color, with an excellent smoothness, an excellent transparency in its depth, and an excellent color tone in its depth.

### Means for Solving the Problem

The present inventors have intensively investigated and found that a multi layered coating film having an excellent appearance (e.g., smoothness), comparable with that obtained by the 4C2B method, and excellent design properties (e.g., transparency and color tone in its depth) is obtained by a method including steps of:

applying a base coating composition comprising a luster color pigment and a coloring pigment on an article; applying a clear coating composition comprising no coloring pigment thereon;

subjecting both of the base coating film and the clear coating film thereon to a baking and/or curing step;

sanding/polishing at least one part of the resulting cured clear coating film;

applying a clear coating composition comprising a coloring pigment allover the partially sanded/polished clear coating film; and

subjecting the clear coating film to a baking and/or curing step.

Accordingly, the present invention provides a method for producing a multi layered coating film as described in detail hereinafter.

A method for producing a multi layered coating film, which comprises steps of:

applying a base coating composition comprising a luster color pigment and a coloring pigment on an article to form a base coating;

applying a first clear coating composition, on the base coating, to form a first clear coating thereon;

subjecting both of the base coating and the first clear coating thereon to baking and/or curing to form a cured base coating film and a cured first clear coating film thereon;

sanding or polishing at least one part of the cured first clear coating film to form a partially sanded or polished first clear coating film;

applying a second clear coating composition allover the first clear coating film to form a second clear coating; and

subjecting the second clear coating to baking and/or curing to form a cured second clear coating film;

wherein

the first clear coating composition comprises no coloring pigment, and

the second clear coating composition comprises a coloring pigment, wherein concentration of the coloring pigment in the second clear coating composition (PWC) is within a range of from 0.001 to 0.8%.

It is preferable that the coloring pigment in the base coating composition includes carbon black.

It is preferable that the coloring pigment in the second clear coating composition includes carbon black.

The present invention also relates to a multi layered coating film obtained/obtainable by the above-described method for producing a multi layered coating film.

### EFFECT OF THE INVENTION

The method according to the present invention can provide a multi layered coating film having an excellent appearance (e.g., smoothness), comparable with the 4C2B method, and excellent design properties (e.g., transparency and color tone in its depth). The present method can provide improved or reduced coating failures upon coating than those of the 4C2B method. In addition, the present method includes easy-to-use steps.

Furthermore, the present method can provide excellent transparency and color tone in its depth. Therefore, the present method is applicable to a formation of a coating film in a dark color. In addition, the present invention can provide a coating film having an excellent black color, i.e., so-called jet-black color or piano-black color. Accordingly, the present method is particularly applicable to a coating on a specific article to be coated such as a luxury car including a highly expensive car and an executive car. Therefore, the present invention can provide significant benefits.

According to the present method, the first clear coating composition contains no coloring pigment in order to form a cured first clear coating film. Therefore, in the case that the cured first clear coating film is partially sanded or polished, ununiformity in color and changes of the hue (including color, color tone and color phase) are not observed. These coating failures were observed in sanding or polishing of the conventional colored clear coating film. According to the present invention, the resulting coating film has an excellent smoothness.

Sanding or polishing on a cured first clear coating film can significantly improve wettability to the following second clear coating composition to be applied. Therefore, it can provide the resulting multi layered coating film with an excellent smoothness.

In addition, during a sanding or polishing step, the present invention can further improve coating failures such as craters, chippings, and adhesion of contaminant such as dirt and dust, etc.

### BRIEF DESCRIPTION OF THE DRAWINGS

FIG. 1 is a schematic view of a multi layered coating film formed by a conventional three coatings and one baking (3C1B) method, which includes a base coating film as a first coating film, a colored clear coating film as a second coating film, and a colorless clear coating film as a third coating film, wherein the first coating film, the second coating film and the third coating film have been simultaneously baked and/or cured.

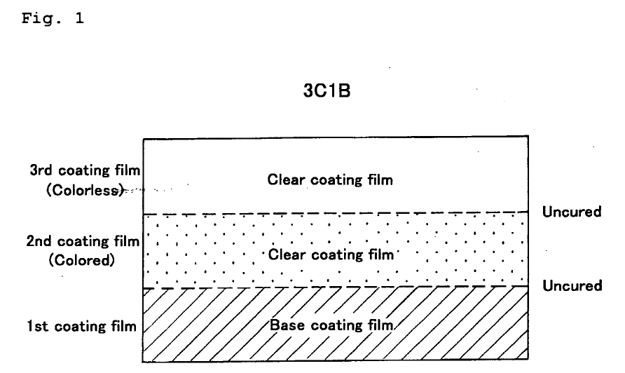

FIG. 2 is a schematic view of a multi layered coating film formed by a conventional three coating and two baking (3C2B) method, which comprises a base coating film as a first coating film, a colored clear coating film as a second coating film, and a colorless clear coating film as a third coating film, wherein the first coating film and the second coating film have been simultaneously baking and/or cured, and if necessary, the second coating film has been sanded or polished, and then the third coating film has been formed thereon.

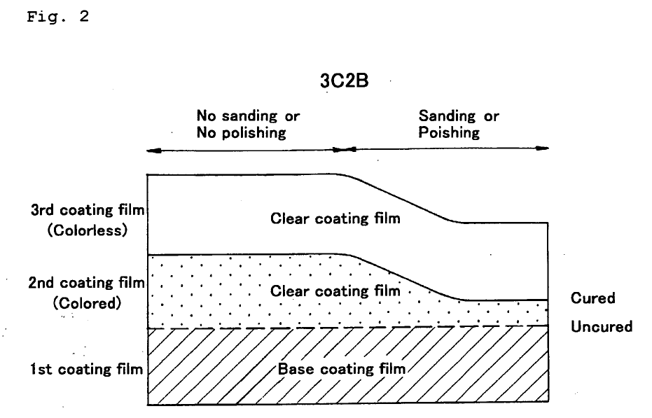

FIG. 3 is a schematic view of one embodiment of the present multi layered coating film according to the present invention.

### DETAILED DESCRIPTION OF THE INVENTION

### Detailed Description of the Preferred Embodiments

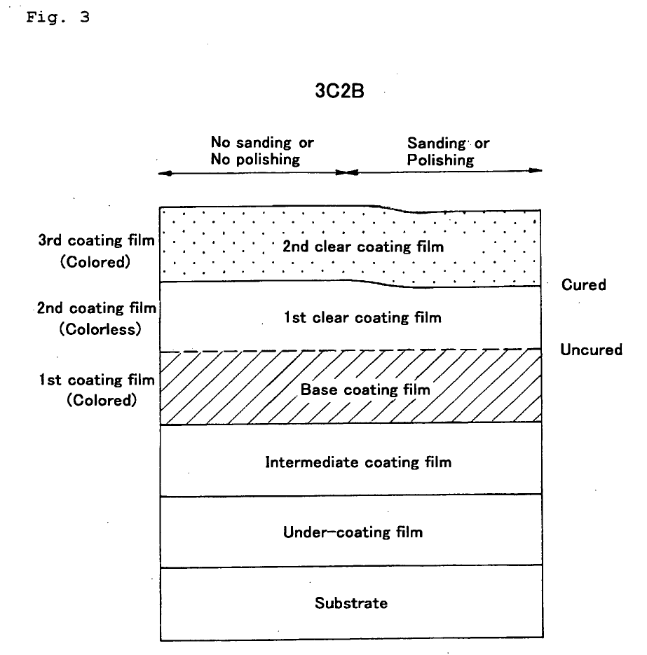

As shown in FIG. 3, the multi layered coating film according to the present invention includes a base coating film, a first clear coating film (i.e., colorless transparent clear layer) and a second clear coating film (i.e., colored clear layer), in this order, on an article (e.g., a substrate including an under-coating film and an intermediate coating film). The method for producing the multi layered coating film according to the present invention includes specific steps, and employs specific coating compositions to form these coating films, each of which is described in detail hereinafter.

The method according to the present invention includes, as a first step, a step of applying a base coating composition comprising a luster color pigment and a coloring pigment on an article to be coated in order to form a base coating film.

Article to be Coated

According to the present invention, the article to be coated as a substrate includes, but is not particularly limited to, for example, metal articles, plastic articles and foams thereof, etc.

Materials for the metal articles include, for example, metals such as iron, steel, copper, aluminum, magnesium, tin and zinc, and alloys containing at lease one of these metals, etc. Specific examples of these metal articles include bodies and parts for vehicles such as automobiles, tracks, auto-bicycles and buses, etc. Particularly preferably, these metal articles may be chemically treated with a chemical conversion agent such as phosphate or chromate in advance of the coating.

Materials for the plastic articles include, for example, polypropylene resins, polycarbonate resins, urethane resins, polyester resins, polystyrene resins, ABS resins, vinyl chloride resins, polyamide resins, etc. Specifically, the plastic articles include, for example, vehicle parts such as spoilers, bumpers, mirror covers, grilles, door knobs, etc. It is more preferable that these plastic articles can be washed with pure water and/or a neutral detergent in advance of the coating. These plastic articles may be subjected to a conductive primer coating to be allowed to be subjected to a further electrostatic coating.

Herein, as a substrate, a metal article superior in an electroconductivity, particularly, an article made of a metal or a cast product, each of which has a metal surface, is particularly preferable, since an electrodeposition coating is possible thereon as an under-coating. An electrodeposition coating composition to form an electrodeposition coating film includes, but is not particularly limited to, cationic and anionic electrodeposition coating compositions. The cationic electrodeposition coating composition is preferable, since the cationic electrodeposition coating composition can provide a coating film having an excellent corrosion resistance.

According to the present invention, an intermediate coating film can be formed on the above-described article. An intermediate coating composition can be employed in order to form an intermediate coating film. The intermediate coating composition may comprise a film forming resin and a curing agent, and if necessary a pigment.

The film forming resin to be added to the above-described intermediate coating composition includes, but is not particularly limited to, for example, an acryl resin, a polyester resin, an alkyd resin, an epoxy resin and an urethane resin. Generally, these film forming resins may be used in a combination with a curing agent. As a curing agent, generally, an amino resin and/or a (blocked) isocyanate resin can be employed in consideration of properties of the resulting intermediate coating film and their costs.

The pigment which may be added to the above-described intermediate coating composition includes a conventional pigment such as an organic coloring pigment, an inorganic coloring pigment, an extender pigment, etc. Inorganic pigments such as titanium oxide and carbon black are preferable. For example, there can be used a gray intermediate coating composition which comprises carbon black and titanium dioxide as predominant pigments; a set gray intermediate coating composition which has a matched brightness with that of an top-coating film thereon; and a so-called color intermediate coating composition which comprises various coloring pigments in a combination. The intermediate coating composition may further comprise a flattened pigment such as aluminum powder, mica, etc.

The intermediate coating composition may comprise additives to be usually added to a coating composition, such as, for example, a surface conditioning agent, an antioxidant and a defoaming agent, in addition to the above-described components.

The above-described under-coating composition and intermediate coating composition may be commercially available or produced. Herein, the method for producing the under-coating film or the intermediate coating film includes, but is not particularly limited to, a conventional method known to those skilled in the art.

Base Coating Composition

A base coating composition can be applied on a surface of an article to be coated according to the present method. The base coating composition includes a known thermosetting coating composition comprising a resin component, a luster color pigment, a coloring pigment, and a solvent, such as a metallic color coating composition, a mica-containing coating composition, etc. If the base coating composition is used in a combination with the first clear coating composition according to the present invention, a base coating composition preferably comprises a luster color pigment(s), which desirably has a good compatibility to the first clear coating composition, in order to provide an excellent flip-flop (F-F) property.

Specifically, the resin component can be prepared from at least one base resin selected from a group consisting of the conventional resins such as an acryl resin, a vinyl resin, a polyester resin, an alkyd resin and an urethane resin, each of which has a crosslinkable functional group (e.g., a hydroxyl group, an epoxy group, a carboxyl group, an alkoxysilane group, and the like); and at least one crosslinking agent to crosslink and/or cure the above-listed resin, which is selected from the group consisting of the conventional agents such as an alkyl-etherified melamine resin, an urea resin, a guanamine resin, a (blocked) polyisocyanate compound, an epoxy compound and a carboxyl group-containing compound. A preferable combination is a combination of 50 to 90% by weight of the base resin and 50 to 10% by weight of the crosslinking agent relative to the total weight of the base resin and the crosslinking agent.

The luster color pigment includes, but is not particularly limited on its shape to, for example, a preferable luster color pigment, which may be a scaly particle and have an average particle size (D₅₀) in a longitudinal length on its plane within a range of from 2 to 50 μm and a thickness within a range of from 0.1 to 5 μm, which may have been colored with the following coloring pigment, more preferably a luster color pigment having an average particle size (D₅₀) within a range of from 10 to 35 μm in order to provide an excellent luster color. Specifically, the luster color pigment includes a luster color pigment made of a metal such as aluminum (e.g., scaly aluminum), copper, zinc, iron, nickel, tin and aluminum oxide, each of which may be colored, or an alloy thereof; and a combination thereof, etc. The luster color pigment further includes mica pigments (e.g., a mica, a surface-coated mica with metal oxide, an interference mica pigment, a white mica pigment, a colored mica pigment), flat iron oxides, graphite pigments, etc.

Examples of the coloring pigment include inorganic pigments such as carbon black, titanium oxide (e.g., titanium dioxide), chrome yellow, zinc oxide, cadmium red, molybdenum red, chromium oxide, prussian blue, cobalt blue, yellow iron oxide and red iron oxide; organic pigments such as an azo pigments (e.g., an azo-chelate pigment, an insoluble azo pigment and a fused azo pigment), a phthalocyanine pigment, a quinacridone pigment, a benzimidazolone pigment, a diketopyrrolopyrrole pigment, an isoindolinone pigment, a threne pigment, a perinone pigment, a perylene pigment, an indigo pigment, a dioxane pigment and a metal-complex pigment. Among these coloring pigments, carbon black is preferable for its jet black color or piano black color property. Furthermore, the coloring pigment may contain an extender pigment (e.g., calcium carbonate, barium sulfate, clay, talc, and the like), etc.

The luster color pigment or the coloring pigment may be used alone or in a combination. At least one luster color pigment and at least one coloring pigment may be used in a combination.

Concentration of all the pigments (i.e., sum of the luster color pigment(s) and the coloring pigment(s)) contained in the base coating composition is preferably within a range of from 0.1 to 50%, more preferably within a range of from 0.5 to 40%, and particularly preferably within a range of from 1.0 to 30%. Herein, the concentration is referred to as a pigment weight content (PWC) [PWC=(Total weight of all luster color pigment(s) weight and all coloring pigment(s) weight)/(Total weight of all luster color pigment(s) weight, all coloring pigment(s) weight, and all resin component(s) weight as a basis of solid content)×100%]. If the PWC is more than 50%, appearance of the resulting coating film will be deteriorated. It is generally preferable that concentration of the coloring pigment(s) (in a pigment weight content (PWC)) is no more than 30%, more preferably within a range of from 0.05 to 20%, and yet more preferably within a range of from 0.1 to 15%. If the concentration of the coloring pigment(s) (in PWC) is more than 30%, there may be a problem that the appearance of the resulting coating film will be deteriorated.

The solvent includes organic solvents. The organic solvent includes conventional organic solvents suitable for a coating composition.

The base coating composition may be a waterborne coating composition, which includes water as a principle solvent. An organic solvent may be added to the waterborne coating composition.

If necessary, the base coating composition may further comprise a conventional additive for a coating composition, such as ultraviolet ray (UV) absorbers, photostabilizers, rheology control agents, viscosity control agents, surface conditioning agents, anti-cissing agents, etc.

According to the present invention, the base coating composition can be directly applied to an article to be coated. The article includes the metal or plastic materials. Preferably, the article is a vehicle body. An under-coating composition such as a cationic electrodeposition coating composition may be applied on the article, and then, if necessary, an intermediate coating composition may be applied thereon. It is preferable that the base coating composition can applied on the cured cationic electrodeposition coating film or the cured intermediate coating film.

The base coating composition can be applied by a means such as an air spraying equipment, an electrostatic coating equipment, etc. Application of the base coating composition is preferable such that thickness of the cured coating film is within a range of from about 10 to about 50 μm. If necessary, an interval for some minutes may be placed at from room temperature to about 100° C. before a first clear coating composition, which is further described below and which can be applied on the uncured base coating film.

The method for producing a multi layered coating film according to the present invention includes a second step of applying a first clear coating composition, on the above-described base coating (i.e., uncured base coating film), to form a first clear coating thereon (i.e., uncured first clear coating film).

First Clear Coating Composition

According to the present invention, a first clear coating composition can be applied on an uncured base coating film resulted from the above-described base coating composition, herein which is referred to as a base coating. The first clear coating composition is a clear coating composition, which does not contain any coloring pigment, to form a colorless transparent clear coating film.

According to the present invention, the first clear coating composition is preferably a clear coating composition in a curing system from the aspects of the properties of the resulting coating film. The clear coating composition in a curing system comprises a thermal curable film forming component and a curing agent. The film forming component includes, for example, a resin component such as an acryl resin, a polyester resin, an epoxy resin, an urethane resin, etc. Among these resin components, the resin component having a curable functional group is preferable. A combination of the resin component and a curing agent such as an amino resin corresponding to the functional group, and if necessary a (blocked) isocyanate resin is preferable. A combination of an acryl resin and/or a polyester resin, which has an active hydrogen containing functional group (e.g., a hydroxyl group), and a curing agent such as a melamine resin, and if necessary a (blocked) polyisocyanate resin is particularly preferable.

Herein, the first clear coating composition which can be used in the present invention may further comprise a conventional additive known to those skilled in the art, such as a surface conditioning agent, a viscosity control agent, an ultraviolet ray absorber, a photostabilizer, etc.

Herein, the above-described clear coating composition does not contain any coloring pigment and any luster color pigment in order to improve ununiformity and gloss of the resulting coating film. Herein, the above-described clear coating composition is not particularly limited on its form and may be in any form such as a form in a solvent type, a water-dispersion type, a water-soluble type, a powder type, or the like.

Preferably, the first clear coating composition comprises (a) an acryl resin, (b) an acryl resin, and (c) a curing agent of a melamine resin:

(a) an acryl resin having a hydroxyl value of 110 to 160 mgKOH/g and an acid value of 5 to 35 mgKOH/g, which is obtainable by a polymerization of (1) an acryl monomer having an alkyl ester group having at least 8 carbon atoms, (2) an acryl monomer having a hydroxyl group wherein at least 4 carbon atoms are placed between the hydroxyl group and the acryl group therein, (3) a monomer having a carboxyl group, and (4) other monomer, wherein content of the acryl monomer (1) having an alkyl ester group having at least 8 carbon atoms is 5 to 20% by weight relative to total monomer weight;

(b) an acryl resin having a hydroxyl value of 10 to 150 mgKOH/g and an epoxy equivalent of 230 to 800 g/eq, which is obtainable by a polymerization of (5) an acryl monomer having a hydroxyl group, (6) an acryl monomer having an epoxy group, and (7) other monomer; and

(c) a curing agent of a melamine resin, which has a solubility parameter (SP value) within a range of from 9.5 to 11.0, and which comprises no less than 50% by weight of an imino group-containing melamine resin. The first clear coating composition may be an organic solvent type coating composition.

Acryl Resin (a)

As described above, the acryl resin (a) is obtainable by a polymerization of (1) an acryl monomer having an alkyl ester group having at least 8 carbon atoms, (2) an acryl monomer having a hydroxyl group wherein at least 4 carbon atoms are placed between the hydroxyl group and the acryl group therein, (3) a monomer having a carboxyl group, and (4) other monomer. Content of the acryl monomer (1) for preparing the acryl resin (a), which has an alkyl ester group having at least 8 carbon atoms, is 5 to 20% by weight, and preferably 5 to 13% by weight, relative to total weight of the acryl monomers for preparing the acryl resin (a). If the content is lower than 5% by weight, it may be difficult to ensure the flip-flop property of the resulting coating film. If the content is more than 20% by weight, the interlayer adhesion may be decreased.

The acryl monomer (1) has an alkyl ester group having at least 8, preferably 8 to 18, and more preferably 10 to 15 carbon atoms. The acryl monomer (1) can prevent the first clear coating from being miscible with the base coating upon a wet-on-wet coating procedure. The acryl monomer (1) can improve flip-flop property of the resulting base coating film. The acryl monomer (1) can suppress a generation of internal curing stress in the first clear coating film. Therefore, curing stress in the second clear coating film thereon can be preferably suppressed. Examples of the monomer (1) include 2-ethylhexyl(meth)acrylate, octyl(meth)acrylate, decyl(meth)acrylate, dodecyl(meth)acrylate, lauryl(meth)acrylate, stearyl(meth)acrylate, tert-butylcyclohexyl(meth)acrylate, dicyclopentadienyl(meth)acrylate, and a mixture thereof. The alkyl ester group having at least 8 carbon atoms can preferably prevent the first clear coating composition from being miscible with the base coating composition. If the alkyl ester group has more than 18 carbon atoms, there may be a deteriorated interlayer adhesion between the first clear coating film and the second clear coating film, which is undesired.

Among others, the preferable acryl monomer (1) has a long and/or straight alkyl ester group at least 8 carbon atoms, such as lauryl(meth)acrylate, decyl(meth)acrylate, dodecyl(meth)acrylate, etc. A single acryl monomer may be used alone or two or more acryl monomers may be used in a combination as an acryl monomer.

According to the present invention, the acryl monomer (2) for the acryl resin (a) essentially has a hydroxyl group, wherein at least 4, preferably 4 to 16, and more preferably 4 to 9 carbon atoms are placed between the hydroxyl group and the acryl group therein. With respect to the wording “between the hydroxyl group and the acryl group therein (i.e., in the acryl monomer (2))”, as used herein, the distance “between the hydroxyl group and the acryl group” is represented by the number of the carbon atoms between them. Herein, the acryl group in the acryl monomer (2) is represented by the following formula:

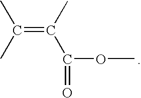

The number of the carbon atoms is counted from the carbon atom attached to the oxygen atom in the acrylate (i.e., —O— in the above-represented formula) to the carbon atom attached to the hydroxyl group in the acryl monomer (2), with the proviso that the number of the carbon atoms to be counted is the number of the carbon atoms in the straight chain between them, wherein the number of the carbon atom(s) in the branched chain is excluded. If an ether and/or ester structure(s) is/are inserted between the hydroxyl group and the acryl group, the number of the other atoms than the carbon atoms, such as oxygen atom(s), is excluded. Therefore, the “acryl monomer (2) having a hydroxyl group wherein at least 4 carbon atoms are placed between the hydroxyl group and the acryl group therein”, as used herein, means an acryl monomer having at least 4 carbon atoms between the hydroxyl group and the acryl group therein (i.e., oxygen atom (—O—) in the above-described acrylate moiety). The above-defined distance between the hydroxyl group and the acryl group has an advantage, since the distance can contribute to the reaction, without any adverse effects due to the steric hindrance. Herein, the acryl monomer having a hydroxyl group, wherein less than 4 carbon atoms are placed between the hydroxyl group and the acryl group therein, may be used as a monomer for preparing the acryl resin (a), which is encompassed in the other monomer (4). Examples of the acryl monomer (2) having a hydroxyl group, wherein at least 4 carbon atoms are placed between the hydroxyl group and the acryl group therein, include, for example, 4-hydroxybutyl(meth)acrylate, 5-hydroxypentyl(meth)acrylate, 6-hydroxyhexyl(meth)acrylate, 7-hdroxyheptyl(meth)acrylate, 8-hydroxyoctyl(meth)acrylate, 7-methyl-8-hydroxyoctyl(meth)acrylate, 2-methyl-8-hydroxyoctyl(meth)acrylate, a lactone-modified acryl monomer which is a reaction product of 1 mol of hydroxyethyl(meth)acrylate with 1 to 5 mol of a lactone such as ε-caprolactone, etc. The caprolactone-modified acryl monomer is commercially available, which includes, for example, Placcel FA-1, Placcel FA-2 and Placcel FA-3 (a monomer which is a addition product of 1, 2 or 3 mol of ε-caprolactone to 1 mol of hydroxyethyl acrylate) commercially available from DAICEL CHEMICAL INDUSTRIES, LTD., under the product names; Placcel FM-1, Placcel FM-2, Placcel FM-3 (a monomer which is a addition product of 1, 2 or 3 mol of ε-caprolactone to 1 mol of hydroxyethyl methacrylate) commercially available from DAICEL CHEMICAL INDUSTRIES, LTD., under the product names; TONE m-100 (a monomer which is an addition product of 2 mol of ε-caprolactone to 1 mol of hydroxyethyl acrylate) commercially available from The Dow Chemical Company (U.S.A.), under the product name, etc.

Examples of the acryl monomer (2) include a monoester of polyether glycol and (meth)acrylic acid; monoether of polyether glycol and hydroxyalkyl(meth)acrylate, such as “BLEMMER AP-150” commercially available from NOF CORPORATION, etc.

Among others, the preferable acryl monomer (2) (as acryl monomer (8)) includes 4-hydroxybutyl(meth)acrylate; Placcel FM-1, FM-2, FA-1 and FA-2 (each of which is a reaction product of hydroxyethyl(meth)acrylate and ε-caprolactone); each of which has a hydroxyl group wherein at least 4 carbon atoms are placed between the hydroxyl group and the acryl group therein. A single preferable monomer may be used alone or two or more preferable monomers may be used in a combination as an acryl monomer.

Particularly preferable amount of the acryl monomer (2) having a hydroxyl group wherein at least 4 carbon atoms are placed between the hydroxyl group and the acryl group therein is no less than 50% by weight relative to the total weight of the weight of the monomers having a hydroxyl group, which are required for preparing the acryl resin (a) (i.e., total weight of the weight of the acryl monomer (4) having a hydroxyl group, and the weight of the acryl monomer (2) having a hydroxyl group wherein at least 4 carbon atoms are placed between the hydroxyl group and the acryl group therein). If the amount of the acryl monomer (2) having a hydroxyl group wherein at least 4 carbon atoms are placed between the hydroxyl group and the acryl group therein is less than 50% by weight relative to the total weight of the monomers having a hydroxyl group, the reactivity of the second clear coating composition to the cured first clear coating film may be insufficient. Therefore, the interlayer adhesion between the first clear coating film and the second clear coating film may be decreased. The most preferable amount is within a range of from 55 to 100% by weight.

The monomer having a carboxyl group (3) includes acrylic acid, methacrylic acid, crotonic acid, 2-acryloyloxyethyl phthalic acid, 2-acryloyloxyethylsuccinic acid, isocrotonic acid, maleic acid, fumaric acid, itaconic acid, 3-vinylsalicylic acid, 3-vinyl-acetylsalicylic acid, 2-acrylamide-2-methylpropane-sulfonic acid, etc. Among others, acrylic acid and methacrylic acid are preferable.

The other monomer (4) includes acryl monomers other than the following monomers (1), (2) and (3):

(1) an acryl monomer having an alkyl ester group having at least 8 carbon atoms,

(2) an acryl monomer having a hydroxyl group wherein at least 4 carbon atoms are placed between the hydroxyl group and the acryl group therein, and

(3) a monomer having a carboxyl group.

The other monomer (4) is copolymerizable with the monomer(s) (1), (2) and/or (3).

The other monomer (4) includes

(meth)acrylates wherein the ester moiety has no more than 7 carbon atoms (e.g., methyl(meth)acrylate, ethyl(meth)acrylate, propyl(meth)acrylate, n-butyl(meth)acrylate, isobutyl(meth)acrylate, tert-butyl(meth)acrylate, hexyl(meth)acrylate, phenyl(meth)acrylate, cyclohexyl(meth)acrylate, etc.);
hydroxyl group-containing acryl monomers other than the acryl monomer (2) having a hydroxyl group wherein at least 4 carbon atoms are placed between the hydroxyl group and the acryl group therein (e.g., 2-hydroxyethyl(meth)acrylate, hydroxypropyl(meth)acrylate, 2-hydroxybutyl(meth)acrylate, etc.);
polymerizable amide compounds (e.g., (meth)acrylamide, N-methylol (meth)acrylamide, N-butoxymethyl(meth)acrylamide, N,N-dimethyl(meth)acrylamide, N,N-dibutyl(meth)acrylamide, N,N-dioctyl(meth)acrylamide, N-monobutyl(meth)acrylamide, N-(2-hydroxyethyl)(meth)acrylamide, etc.);
polymerizable aromatic compounds (e.g., styrene, α-methylstyrene, vinyl ketone, tert-butylstyrene, para-chlorostyrene and vinyl naphthalene, etc.);
polymerizable nitriles (e.g., acrylonitrile, methacrylonitrile, etc.);
vinyl esters (e.g., vinyl acetate, vinyl propionate, etc.);
dienes (e.g., butadiene, isoprene, etc.);
α-olefines;
vinyl esters; and
dienes, etc.
The other monomer (4) can be appropriately selected depending on the purpose.

It is preferable that the content of the other monomer (4) is less than 35% by weight relative to total monomer weight, i.e., total weight of the monomer mixture.

The acryl resin (a) can be prepared by a conventional method, for example, wherein the above-described monomers are subjected to a solution polymerization in the presence of a catalyst for a radical polymerization.

The content of the monomer can be determined such that the resulting acryl resin has a hydroxyl value within a range of from 110 to 160 mgKOH/g, and preferably within a range of from 120 to 150 mgKOH/g. If the hydroxyl value is less than 110 mgKOH/g, the resulting coating film may have an insufficient curability. If the hydroxyl value is more than 160 mgKOH/g, the resulting coating film may have a decreased water resistance. The acryl resin (a) has an acid value within a range of from 5 to 35 mgKOH/g, and preferably within a range of from 10 to 30 mgKOH/g. If the acid value is more than 35 mgKOH/g, the crosslinking reaction can extremely proceed, the resulting coating film may have an insufficient flexibility, and the resulting coating film may have a decreased water resistance. If the acid value is less than 5 mgKOH/g, the resulting coating film may have a decreased curability.

The acryl resin (a) preferably has a number average molecular weight within a range of from 2000 to 15000. If the number average molecular weight is less than 2000, the resulting coating film may have an insufficient hardness. If the number average molecular weight is more than 15000, the resulting coating film may have a deteriorated appearance. The acryl resin (a) has a particular preferable number average molecular weight within a range of from 2500 to 5000.

Herein, the number average molecular weight can be determined by a gel permeation chromatography (GPC), wherein the number average molecular weight is calculated from the found measurement value based on the polystyrene standard.

Acryl Resin (b)

The acryl resin (b) is an acryl resin obtainable by a polymerization of (5) an acryl monomer having a hydroxyl group, (6) an acryl monomer having an epoxy group, and (7) other monomer. An additional monomer for the synthesis of the acryl resin (b), other than the above-described monomers (5) to (7), may be employed with the proviso that the additional monomer does not adversely effect on the resulting acryl resin (b). The acryl monomer (5), which has a hydroxyl group, encompasses

the above-described acryl monomer (2), which has a hydroxyl group, wherein at least 4 carbon atoms are placed between the hydroxyl group and the acryl group therein; and

other acryl monomer, which has a hydroxyl group,

wherein less than 4 carbon atoms are placed between the hydroxyl group and the acryl group therein.
Examples of the acryl monomer (5) include those exemplified in the above-described acryl monomer (2), which has a hydroxyl group, wherein at least 4 carbon atoms are placed between the hydroxyl group and the acryl group therein, and the other acryl monomer having a hydroxyl group, such as 2-hydroxyethyl(meth)acrylate, hydroxypropyl(meth)acrylate, 2-hydroxybutyl(meth)acrylate, etc. More preferable acryl monomer (5), which has a hydroxyl group, includes Placcel FM-1, FM-2, FA-1 and FA-2, each of which is a reaction product of 4-hydroxybutyl(meth)acrylate or hydroxy ethyl(meth)acrylate with ε-caprolactone, which is referred to as a hydroxyl group-containing monomer (8). Content of the hydroxyl group-containing monomer (8) is preferably no less than 50% by weight relative to the total weight of the acryl monomer (5) which has a hydroxyl group. If the content is less than 50% by weight, the reactivity of the second clear coating composition to the cured first clear coating film may be insufficient. As a result, the interlayer adhesion between the first clear coating film and the second clear coating film may be deteriorated.

The acryl monomer (6), which has an epoxy group, includes, but is not particularly limited to, an acryl monomer having an epoxy group and a polymerizable unsaturated double bond in a molecule, such as glycidyl(meth)acrylate, β-methylglycidyl(meth)acrylate, glycidyl ether of 4-hydroxybutyl(meth)acrylate, (meth)acrylate of 3,4-epoxycyclohexanemethanol, etc. The preferable acryl monomer (6) is glycidyl(meth)acrylate or glycidyl ether of 4-hydroxybutyl(meth)acrylate from the aspect of the reactivity.

The other monomer (7) for preparing the acryl resin (b) includes acryl monomers other than the following acryl monomers (5) and (6):

(5) the above-described acryl monomer having a hydroxyl group, and

(6) the above-described acryl monomer having an epoxy group.

The other monomer (7) is copolymerizable with the acryl monomer(s) (5) and/or (6). The other monomer (7) includes, for example,
(meth)acrylates (e.g., methyl(meth)acrylate, ethyl(meth)acrylate, propyl(meth)acrylate, n-butyl(meth)acrylate, isobutyl(meth)acrylate, tert-butyl(meth)acrylate, hexyl(meth)acrylate, 2-ethylhexyl(meth)acrylate, octyl(meth)acrylate, decyl(meth)acrylate, lauryl(meth)acrylate, stearyl(meth)acrylate, isoboronyl(meth)acrylate, phenyl(meth)acrylate, cyclohexyl(meth)acrylate, etc.);
polymerizable amide compounds (e.g., (meth)acrylamide, N-methylol (meth)acrylamide, N-butoxymethyl(meth)acrylamide, N,N-dimethyl(meth)acrylamide, N,N-dibutyl(meth)acrylamide, N,N-dioctyl(meth)acrylamide, N-monobutyl(meth)acrylamide, N-(2-hydroxyethyl)(meth)acrylamide, etc.);
polymerizable aromatic compounds (e.g., styrene, α-methylstyrene, vinyl ketone, tert-butylstyrene, para-chlorostyrene and vinyl naphthalene, etc.);
polymerizable nitriles (e.g., acrylonitrile, methacrylonitrile, etc.);
vinyl esters (e.g., vinyl acetate, vinyl propionate, etc.);
dienes (e.g., butadiene, isoprene, etc.);
α-olefines;
vinyl esters;
dienes; etc.
The other monomer (7) can be appropriately selected depending on the purpose.

It is preferable that the content of the other monomer (7) is less than 35% by weight relative to the total monomer weight, i.e., total weight of the monomer mixture.

It is preferable that the acryl resin (b) has a hydroxyl value of 10 to 150 mgKOH/g, and more preferably 20 to 130 mgKOH/g, an epoxy equivalent of 230 to 800 g/eq, and more preferably 250 to 700 g/eq, and a preferable number average molecular weight of about 1500 to 12000, and more preferably 2000 to 4000. If the hydroxyl value is less than 10-mgKOH/g, the adhesion of the resulting coating film may be decreased. If the hydroxy value is more than 150 mgKOH/g, the water resistance and/or flip-flop property of the resulting coating film may be deteriorated. Therefore, these circumstances are not desirable. If the epoxy equivalent is less than 230 g/eq, water resistance of the resulting multi layered coating film including the second clear coating film may be decreased. If the epoxy equivalent is more than 800 g/eq, the adhesion of the resulting coating film may be deteriorated. If the number average molecular weight is less than 1500, the resulting coating film may have an insufficient hardness. If the number average molecular weight is more than 12000, the resulting coating film may have a deteriorated appearance.

Curing Agent of Melamine Resin (c)

The curing agent (c) of a melamine resin has a solubility parameter (SP value) within a range of from 9.5 to 11.0, and comprises no less than 50% by weight of an imino group-containing melamine resin.

The imino group-containing melamine resin (c) has a partial structure, i.e., melamine structure, as described below:

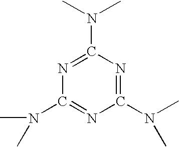

wherein it is preferable that at least one nitrogen atom forms an imino group (i.e., —NH— or ═NH).

The nitrogen (N) atoms attached to the triazine moiety in the above melamine structure may have 6 substituents. The imino group-containing melamine resin, which is also referred to as an imino-type melamine resin, preferably has at least one imino groups formed with the nitrogen atoms. The nitrogen atom(s) other than the imino group may have other substituent(s). The imino group-containing melamine resin may have other substituents at the nitrogen atoms each of which has an imino group and other nitrogen atom with its imino group.

The first clear coating composition comprises the melamine resin, wherein the content of the imino group-containing melamine resin is essentially no less than 50% by weight. If the content is less than 50% by weight, the interlayer initial adhesion in the resulting multi layered coating film may be decreased. It is preferable that the content of the imino group-containing melamine resin is within a range of form 50 to 75% by weight relative to total weight of the melamine resin. As stated above, the imino group-containing melamine resin has at least one imino group in the repeating unit (in average). If the imino group-containing melamine resin contains less than one imino group in the repeating unit (in average), the curability and adhesion of the resulting coating film may be decreased. If the imino group-containing melamine resin contains unnecessary imino groups, e.g., no less than 3.5 imino groups in the repeating unit (in average), the resulting coating film may have a hardness and a brittleness, and therefore the resulting coating film may have poor water resistance and poor impact resistance, which is not preferable.

Examples of the melamine resin having at least one imino group include U-VAN-125 (commercially available from Mitsui Chemicals, Inc., under a product name), U-VAN-225 (commercially available from Mitsui Chemicals, Inc., under a product name), Cymel 254 (commercially available from Mitsui Cytec Industries Inc., under a product name), Mycoat 508 (commercially available from Mitsui Cytec Industries Inc., under a product name), etc.

The melamine resin has a solubility parameter (SP value) within a range of from 9.5 to 11.0, and preferably within a range of from 9.7 to 10.9. If the SP value is more than 11.0, the adhesion of the resulting coating film to the second clear coating composition may be decreased, and the water resistance of the resulting coating film may be decreased. If the SP value is less than 9.5, the transparency of the resulting coating film may be decreased. Therefore, these circumstances are not desirable. The imino group-containing melamine resin has an individual SP value. The SP value is the abbreviation of solubility parameter, and therefore SP value is an index of a solubility. It is indicated that SP value is larger, the polarity is higher, whereas, SP value is smaller, the polarity is lower.

The imino group-containing melamine resin has a possibility for the self-condensation. It is considered that the interlayer adhesion between the first clear coating film and the second clear coating film can be improved due to the increased number of the residual unreacted hydroxyl groups in the first clear coating film. If the content of the imino group-containing melamine resin is more than 75% by weight relative to the total weight of the melamine resin, the self-condensation may excessively proceed, and therefore the resulting coating film may lose the flexibility and the water resistance of the resulting coating film may be decreased. If the content of the imino group-containing melamine resin is less than 50% by weight, it may be difficult to exist the unreacted hydroxyl groups in the first clear coating film, and therefore the interlayer adhesion between the first clear coating film and the second clear coating film may be decreased. Therefore, these circumstances are not desirable.

Generally, measurements for resin SP value are known in the art, wherein a resin is dissolved in a good solvent having a given SP value to give a solution, the solution can be subjected to turbidimetric titration with a poor solvent having a given higher SP value than that of the good solvent, and/or with a poor solvent having a given lower SP value than that of the good solvent to determine a resin SP value (see Reference 1: C. M. Hansen, J. Paint. Tech., 39 [505], 104 (1967) and Reference 2: “Color materials (SHIKIZAI)” by Toshikatsu Kobayashi, 77 [4], 188-192 (2004)).

For example, a resin SP value can be determined according to the following conditions.

Measuring temperature: 20° C.

Sample: 0.5 g of a resin is weighed in a 100 ml beaker, 10 ml of a good solvent is added to the beaker with a whole pipette, and then the resin is dissolved in the solvent with a magnetic stirrer to give a sample.

Good solvent: Acetone (SP value (δg) (measured by a Hansen method): 9.77)

Poor solvent: Hexane (SP value (δpl): 7.24 (i.e., a lower SP value)) or deionized water (SP value (δph): 23.50 (i.e., a higher SP value))

Turbidimetric titration: Poor solvent (hexane) is added dropwise to the sample with a 50 ml burette, and then at a point at which turbidity is generated, the titration amount (hexane) is recorded. Poor solvent (deionized water) is added dropwise to another sample with a 50 ml burette, and then at a point at which turbidity is generated, the titration amount (deionized water) is recorded.

φpl: volume proportion of hexane

φph: volume proportion of deionized water

The SP values (δml and δmh, wherein SP value (δml) is a volume of the added hexane at a point turbidity is generated by the addition of hexane (i.e., SP value of the hexane containing mixture) and SP value (δmh) is a volume of the added deionized water at a point turbidity is generated by the addition of deionized water (i.e., SP value of the deionized water containing mixture)) can be independently represented by an average (in volume) of SP values of the good solvent and the poor solvent.

δml=φpl δpl+(1−φpl)δg (Equation I)

δmh=φph δph+(1−φph)δg (Equation II)

The resin SP value (δpoly) is an average of the SP values (δml and δmh), which is determined by the following equation:

δpoly=(δml+δmh)/2 (Equation III)

The content of the acryl resin (a) is preferably within a range of from 50 to 85% by weight, and particularly preferably within a range of from 60 to 80% by weight relative to the weight of the resin solid component in the coating composition. If the content is more than 85% by weight, the adhesion to the coating film thereon may be decreased. If the content is less than 50% by weight, the anti-miscibility to the base coating film may be decreased.

The content of the acryl resin (b) is preferably within a range of from 5 to 30% by weight, and particularly preferably within a range of from 8 to 25% by weight relative to the weight of the resin solid component in the coating composition. If the content is more than 30% by weight, the resulting coating film may have an excessive hardness and be brittle. If the content is less than 5% by weight, the adhesion to the coating film thereon may be decreased.

The content of the melamine resin (c) is preferably within a range of from 10 to 40% by weight, and particularly preferably within a range of from 15 to 35% by weight relative to the weight of the resin solid component in the coating composition. If the content is more than 40% by weight, the resulting coating film may have an excessive hardness and be brittle. If the content is less than 10% by weight, the curability of the coating composition may be decreased.

The first clear coating composition according to the present invention may further comprise, if necessary, a conventional additive(s) for a coating composition, such as curing catalysts, ultraviolet ray (UV) absorbers, photostabilizers, rheology control agents, anti-cissing agents, etc.

A method for preparing the first clear coating composition includes, but is not particularly limited to, any conventional methods known to those skilled in the art.

The first clear coating composition is preferably applied on the uncured base coating film resulted from the above-described base coating composition, herein which is sometimes referred to as a base coating. The application is preferably carried out by a means of an air spraying, an electrostatic coating, or the like. Thickness of the resulting cured first clear coating film is preferably within a range of from 10 to 50 μm. If necessary, after applying the first clear coating composition, the applied coating composition may be allowed to be left at a temperature within a range of from room temperature to about 100° C. for several minutes before application of a further clear coating composition thereon.

According to the present invention, the first clear coating composition can be applied, in order to form a colorless transparent coating film, on the colored base coating film resulted from the colored base coating composition. The resulting first clear coating film on the base coating film can provide superior design properties, particularly in transparency and color tone in its depth, to those of the base coating film in a single layer resulted from the base coating composition.

The method for producing the multi layered coating film according to the present invention includes a third step of subjecting both of the above-described base coating and first clear coating thereon to baking and/or curing (two coating and one baking (2C1B) method) to form a cured base coating film and a cured first clear coating film thereon.

Temperature for carrying out the baking and/or curing is within a range of from 100 to 180° C., preferably within a range of from 120 to 160° C., and more preferably within a range of from 130 to 150° C. Time period for carrying out the baking and/or curing is within a range of from 10 to 60 minutes, preferably within a range of from 15 to 50 minutes, and more preferably within a range of from 20 to 40 minutes.

The method for producing the multi layered coating film according to the present invention includes a fourth step of sanding or polishing at least one part of the cured first clear coating film to form a partially sanded or polished first clear coating film.

According to the present invention, the first cured clear coating film can be sanded or polished on its surface. The sanding or polishing can be applied at least partially or totally on the surface of the first cured clear coating film. The sanding or polishing can provide an excellent smoothness on the surface. Furthermore, the sanding or polishing can significantly improve wettability (i.e., a contact angle) to the second clear coating composition to be applied thereon in the following step. FIG. 3 schematically illustrates one embodiment of a multi layered coating film according to the present invention, wherein the sanded or polished area on the boundary between the first clear coating film and the second clear coating film is schematically illustrated.

Herein, simultaneously, the sanding or polishing can improve uniformity of the coating film such as sagging, popping, etc. In addition, if necessary, partial coating failures such as craters, chippings, and adhesion of contaminant (e.g., dirt and dust), and the like can be repaired.

For example, in the case of that the article to be coated is a body of a vehicle such as an automobile, it is preferable that the sanding or polishing is carried out on a part wherein an excellent appearance such as smoothness is required, e.g., a bonnet, a fender, a pillar, a roof, a trunk lid, etc.

It is preferable that the sanding or polishing is carried out by using an abrasive, for example, such as sandpaper (in a range of from #600 to #2000). It is more preferable that the sanding or polishing is carried out by wet-sanding with water so-called water-sanding.

Herein, with respect to the unevenness part (i.e., undulation and rounds) of the resulting coating film, the slightly sanding or polishing of the protruded area in order to be flatten can achieve more improved smoothness on the resulting coating film. It is preferable that the craters including the protruded area can be uniformly sanded or polished. Herein, in the case of partially sanding or polishing, it is preferable that the sanding or polishing can be carried out with giving a gentle slope, along with the sanding or polishing direction in its depth, from an area to be sanded or polished to an area not to be sanded or polished.

After the above-described sanding or polishing step, it is preferable that wiping or air-blowing can be applied in order to remove off sanding or polishing dust, dirt, dust, and the like.

After the above-described sanding or polishing step, the method for producing the multi layered coating film according to the present invention includes a fifth step of applying a second clear coating composition allover the first clear coating film to form a second clear coating (i.e., uncured second clear coating film). Hereinafter, the second clear coating composition is described in detail, which is a colored clear coating composition containing a coloring pigment.

Second Clear Coating Composition

The second clear coating composition is a clear coating composition comprising a polyepoxide and a polycarboxylic acid (i.e., a clear coating composition in an acid-epoxy curing system), or an urethane clear coating composition comprising a hydroxyl group-containing resin and a polyisocyanate curing agent. Herein, the second clear coating composition is a colored clear coating composition further comprising a coloring pigment.

The second clear coating composition is preferably a clear coating composition in an acid-epoxy curing system, which comprises a coloring pigment. Particularly preferably, the clear coating composition in an acid-epoxy curing system comprises (a) an acid anhydride group-containing acryl resin, (b) a carboxyl group-containing polyester resin, and (c) an acryl resin having a hydroxyl group and an epoxy group. The second clear coating composition comprising the components (a), (b) and (c) in high solid contents can provide a coating film having an excellent acid resistance. The acid anhydride group-containing acryl resin (a) is preferably half-esterified on the acid anhydride group therein with an alcohol component, such as an alcohol having a low molecular weight, from the aspect of the storage stability. The carboxyl group-containing polyester resin (b) may further have a hydroxyl group.

The acid anhydride group-containing acryl resin (a), the carboxyl group-containing polyester resin (b) and the acryl resin (c) having a hydroxyl group and an epoxy group can be combined in an appropriate amount known to those skilled in the art in accordance with a conventional method known to those skilled in the art.

It is preferable that the molar ratio of the carboxyl group(s) of the acid anhydride group-containing acryl resin (a) and the carboxyl group(s) of the carboxyl group-containing polyester resin (b) to the epoxy group(s) of the acryl resin (c) having a hydroxyl group and an epoxy group [the carboxyl group(s) in the components (a) and (b)/the epoxy group(s) in the component (c)] is within a range of a ratio of from 1/1.4 to 1/0.6, and preferably within a range of a ratio of from 1/1.2 to 1/0.8; and the molar ratio of the carboxyl group(s) of the acid anhydride group-containing acryl resin (a), which is/are due to the acid anhydride group therein, to the hydroxyl group(s) of the carboxyl group-containing polyester resin (b) and the hydroxyl group(s) of the acryl resin (c) (having a hydroxyl group and an epoxy group) [the carboxyl group(s) in the component (a)/the hydroxyl group(s) in the components (b) and (c)] is within a range of a ratio of from 1/2.0 to 1/0.5, and more preferably within a range of a ratio of from 1/1.5 to 1/0.7.

If the molar ratio of the carboxyl group(s) in the components (a) and (b)/the epoxy group(s) in the component (c) is more than 1/0.6, the curability of the resulting coating composition may be decreased. If the molar ratio [i.e., the carboxyl group(s) in the components (a) and (b)/the epoxy group(s) in the component (c)] is less than 1/1.4, the resulting coating film may be yellowed. If the molar ratio of the carboxyl group(s) in the component (a), which is/are due to the acid anhydride group therein/the hydroxyl group(s) in the components (b) and (c)] is more than 1/0.5, the curability of the resulting coating composition may be decreased. If the molar ratio [i.e., the carboxyl group(s) in the component (a)/the hydroxyl group(s) in the components (b) and (c)] is less than 1/2.0, the excessive hydroxyl groups may reduce the water resistance. These contents can be determined in accordance with a calculation method well known to those skilled in the art with hydroxyl values, acid values and epoxy equivalents of the polymers.

According to the curing system of thus prepared second clear coating composition employed in the present invention, the heating of the acid anhydride group-containing acryl resin (a) allows the acid anhydride group in the resin (a) to react with the hydroxyl group in the carboxyl group-containing polyester resin (b) or the acryl resin (c) (having a hydroxyl group and an epoxy group). The reaction can provide a crosslinking and regenerates a carboxyl group in the reaction product. The carboxyl group in the reaction product or the carboxyl group in the carboxyl group-containing polyester resin (b) can react with the epoxy group of the acryl resin (c) (having a hydroxyl group and an epoxy group) to form a crosslinking. As described above, the reaction between these three resins (i.e., polymers) can promote the curing in order to provide a high crosslinking density.

Preferably, the second clear coating composition includes an urethane clear coating composition further comprising a coloring pigment. The urethane clear coating composition includes a clear coating composition comprising a hydroxyl group-containing resin and an isocyanate compound as a curing agent. The isocyanate compound, as a curing agent, includes, but is not particularly limited to, for example,

aliphatic isocyanates such as trimethylene diisocyanate, tetramethylene diisocyanate, pentamethylene diisocyanate, hexamethylene diisocyanate (HDI), trimethylhexamethylene diisocyanate;
aliphatic-cyclic isocyanates such as 1,3-cyclopentane diisocyanate, 1,4-cyclohexane diisocyanate, 1,2-cyclohexane diisocyanate;
aromatic isocyanates such as xylylene diisocyanate (XDI), 2,4-tolylene diisocyanate (TDI), 2,6-tolylene diisocyanate;
alicyclic isocyanates such as isophorone diisocyanate (IPDI), norbornane diisocyanate methyl;
multimers thereof such as biurets and nulates; and
mixtures thereof, etc.

The hydroxyl group-containing resin has a hydroxyl value preferably within a range of from 20 to 200 mgKOH/g. If the hydroxyl value is more than 200 mgKOH/g, the resulting coating film may have a reduced water resistance. If the hydroxyl value is less than 20 mgKOH/g, the resulting coating film may have an inferior curability. The lower limit of the hydroxyl value is more preferably 30 mgKOH/g. The upper limit of the hydroxyl value is more preferably 180 mgKOH/g.

The hydroxyl group-containing resin has a number average molecular weight within a range of from preferably 1000 to 20000. If the number average molecular weight is less than 1000, the application workability and curability may be insufficient. If the number average molecular weight is more than 20000, the non-volatile content upon coating is too low, therefore the application workability may be inferior. The lower limit of the number average molecular weight is more preferably 2000. The upper limit of the number average molecular weight is more preferably 15000. Herein, the molecular weight can be determined by a GPC method wherein a styrene polymer is a standard.

The hydroxyl group-containing resin further has an acid value preferably within a range of from 2 to 30 mgKOH/g. If the acid value of the hydroxyl group-containing resin is more than 30 mgKOH/g, the resulting coating film may have an inferior water resistance. If the acid value of the hydroxyl group-containing resin is less than 2 mgKOH/g, the resulting coating film may have a decreased curability. The lower limit of the acid value is more preferably 3 mgKOH/g. The upper limit of the acid value is more preferably 25 mgKOH/g.

Proportion of the isocyanate compound to the hydroxyl group-containing resin can be appropriately determined depending on the objective application. In the second clear coating composition employed according to the present invention, it is preferable that the proportion (as an equivalent ratio) of the isocyanate group (NCO) to the hydroxyl group (OH) is within a range of a ratio of from 0.5 to 1.7 [NCO/OH]. If the proportion is less than 0.5, the curability may be insufficient. If the proportion is more than 1.7, the resulting coating film may have an excessive hardness and be brittle. The lower limit of the proportion is more preferably 0.7. The upper limit of the proportion is more preferably 1.5. The form of the clear coating composition may be in a solvent type or a waterborne type.

The hydroxyl group-containing resin includes, but is not particularly limited to, for example, acryl resins, polyester resins, alkyd resins, polyether resins, etc. One single resin may be used alone, or two or more resins may be used in a combination. Among others, the acryl resin and/or the polyester resin are/is preferable in an aspect of resulting film properties such as weather resistance and water resistance.

The coloring pigment to be contained in the second clear coating composition includes, for example, inorganic pigments such as carbon black, titanium oxide (e.g., titanium dioxide), zinc oxide, cadmium red, molybdenum red, chrome yellow, chromium oxide, prussian blue, cobalt blue, yellow iron oxide and red iron oxide; organic pigments such as an azo pigment (e.g., an azo-chelate pigment, an insoluble azo pigment and a fused azo pigment), a phthalocyanine pigment, a quinacridone pigment, a benzimidazolone pigment, a diketopyrrolopyrrole pigment, an isoindolinone pigment, a threne pigment, a perinone pigment, a perylene pigment, an indigo pigment, a dioxane pigment and a metal-complex pigment. Among these coloring pigments, carbon black is preferable for its jet black color or piano black color property.

The second clear coating film resulted from the second clear coating composition has a hue. It is preferable that the second clear coating film has a similar hue to that of the base coating film. It is more preferable that the second clear coating film has a hue identical to that of the base coating film. As used herein, the “similar” hue includes at least adjacent two hues in Hue Circle in Mansell System (in 10 hues). Accordingly, the present invention can provide the resulting multi layered coating film with a dark color having an improved color tone in its depth and an improved transparency in its depth.

Concentration of all the coloring pigments in the second clear coating composition (i.e., pigment weight content (PWC)) [PWC=(Total weight of all coloring pigment(s))/(Total weight of all coloring pigment(s) weight and all resin component(s) weight as a basis of solid content)×100%] is within a range of from 0.001 to 0.8%, preferably within a range of from 0.005 to 0.5%, and more preferably within a range of from 0.01 to 0.3%. When the concentration (in PWC) of the coloring pigment(s) is less than 0.001%, there may be problems such that excessive transparency can provide hue without desired color tone in its depth. When the concentration (in PWC) of the coloring pigment(s) exceeds 0.8%, there may be problems such that the second clear coating film is tinted so that the hue of the base coating film as the first layer is not clearly observed, and therefore the resulting multi layered coating film does not have a desired color tone in its depth, and the resulting multi layered coating film will be denatured or discolored along with the decrease in its weather resistance, and the like.

The second clear coating composition may further comprise an ultraviolet ray (UV) absorbing agent, a hindered amine photostabilizer, an antioxidant, or the like, in order to improve a weather resistance of the resulting coating film. The second clear coating composition may further comprise a rheology control agent, a viscosity control agent, such as crosslinked resin particles, and/or a surface conditioning agent to improve an appearance of the resulting coating film. If necessary, it is preferable that the second clear coating composition may further comprise a curing catalyst.

If the second clear coating composition comprises a crosslinked resin particles, the content of the crosslinked resin particles is within a range of from 0.01 to 10 parts by weight, and preferably 0.1 to 5 parts by weight, relative to 100 parts by weight of the solid resin contents in the second clear coating composition. If the content of the crosslinked resin particles is more than 10 parts by weight, the resulting coating appearance may be deteriorated. If the content of the crosslinked resin particles is less than 0.01 part by weight, the rheology controlling effects may not be provided.

In the case that the resin in the coating composition employed in the present invention has an acid group as a functional group, the acid group can be neutralized with an amine to give a waterborne coating composition wherein water is a medium.

Specifically, the clear coating composition comprising a polyepoxide and a polycarboxylic acid in an acid-epoxy curing system is preferably commercially available under a product name of “MACFLOW 0-570 CLEAR”, “MACFLOW 0-1820 CLEAR” or “MACFLOW 0-1800 CLEAR” from NIPPON PAINT Co., Ltd., from an aspect of an acid resistance. The urethane clear coating composition comprising a hydroxyl group-containing resin and a polyisocyanate curing agent is preferably commercially available under a product name of “R290S CLEAR” from Nippon Bee Chemical Co., Ltd.

A method for producing the second clear coating composition includes, but is not particularly limited to, any methods well known to those skilled in the art. For example, the second clear coating composition can be prepared, according to a conventional method known to those skilled in the art, by adding the coloring pigment to a commercially available clear coating composition in an acid-epoxy curing system or urethane system.

It is preferable that the second clear coating composition can be applied on the whole surface of the cured first clear coating film resulted from the above-described first clear coating composition by a means of an air spraying, an electrostatic coating, or the like, so that the resulting cured coating film has a thickness within a range of from 20 to 200 μm.

The method for producing the multi layered coating film according to the present invention includes a sixth step of subjecting the second clear coating (i.e., uncured second clear coating film) to baking and/or curing to form a cured second clear coating film.

Temperature for carrying out the baking and/or curing is within a range of from 100 to 180° C., preferably within a range of from 120 to 160° C., and more preferably within a range of from 130 to 150° C. Time period for carrying out for baking and/or curing is within a range of from 10 to 60 minutes, preferably within a range of from 15 to 50 minutes, and more preferably within a range of from 20 to 40 minutes.

As shown in FIG. 3, the method according to the present invention can produce a multi layered coating film wherein, on an article (e.g., a substrate, on which an under-coating film and an intermediate coating film have been formed in this order), as a top-coating film, a base coating film (i.e., a colored base layer), a first clear coating film (i.e., a colorless transparent clear layer), and a second clear coating film (i.e., a colored clear layer) is formed in this order. The first clear coating film can be formed with a clear coating composition without any coloring pigments. Therefore, the cured first clear coating film can be partially or wholly sanded or polished. As a result, the sanding or polishing can provide the resulting coating film with an excellent smoothness. Herein, the sanding or polishing of the cured first clear coating film does not provide the resulting coating film with any ununiformity in color or changes in hue. Whereas, sanding or polishing of the conventional colored clear coating film provides ununiformity in color, and changes in hue. In addition, while sanding or polishing, it is simultaneously possible to improve (or repair) any coating failures (e.g., craters, chippings, and adhesion of contaminant such as dirt and dust, and the like). According to the present invention, the sanding or polishing can provide a superior wettability (i.e., a significant contact by low angle) to the second clear coating composition to be applied thereon. Finally, the present invention can provide a multi layered coating film with an excellent smoothness. The multi layered coating film formed according to the present method has two clear layers, i.e., the colorless transparent clear layer and the colored clear layer thereon. Therefore, the present invention can provide superior transparency and color tone in its depth equal to, or comparable with, those obtained by 4C2B method. Furthermore, according to the present invention, the base coating composition and/or the second clear coating composition can contain a coloring pigment such as carbon black. Therefore, the present invention can provide the resulting multi layered coating film with a dark color having an excellent transparency and color tone in its depth. As a result, the present invention can provide the resulting multi layered coating film with an excellent jet black color or piano black color property. Such significant characteristics provided by the present invention have a large benefit in the coating of a specific article to be coated such as a luxury car which requires significantly excellent design property. Herein, the coating method according to the present invention substantially corresponds to a 3C2B method which is convenient than conventional 4C2B method.

### EXAMPLES

The present invention is further described hereinafter in detail in accordance with the following Examples in comparison with the Comparative Examples. In the Examples and the Comparative Examples, “part(s)” and “%” are based on weight unless otherwise specified. Those skilled in the art will appreciate that the present invention is not limited to these examples.

### Preparation Example 1

### Preparation of Base Coating Composition 1

A thermosetting acryl resin manufactured by Nippon Paint Co., Ltd. (having a hydroxyl value of 45 mgKOH/g, an acid value of 15 mgKOH/g, a number average molecular weight of 21000, and a solid content of 50% by weight), a thermosetting polyester resin manufactured by Nippon Paint Co., Ltd. (having a hydroxyl value of 110 mgKOH/g, an acid value of 8 mgKOH/g, a number average molecular weight of 2700, a weight average molecular weight of 16000, and a solid content of 60% by weight), and U-VAN 20N60 (which was a butyl-etherified melamine resin, manufactured by Mitsui Toatsu Chemicals Inc., having a solid content of 60%) were charged into a stainless beaker [in a weight ratio of 60/15/25 (acryl resin/polyester resin/melamine resin) as a basis of solid content]. Coloring pigments: CYANINE BLUE G-314 (which was an organic blue pigment manufactured by Sanyo Shikiso K. K. [PWC=2.3%]), Hostaperm Violet BL (which was an organic violet pigment manufactured by Clariant Co. [PWC=1.8%]) and RAVEN 5000 ULTRA III POWDER (which was a carbon black pigment manufactured by COLUMBIAN CHEMICALS Co., Ltd. [PWC=1.3%]); and a luster color pigment: Iriojin 225 WNT (which was an interference mica luster color pigment manufactured by Merck & Co., Inc. [PWC=4.5%]); and then 8% by weight of crosslinked resin particles (which was a viscosity control agent, manufactured by Nippon Paint Co., Ltd., having an average particle size of 55 nm and a solid content of 20%), and 0.8% by weight of a surface conditioning agent of an acryl resin, relative to solid resin content, were further added thereto and mixed to give a base coating composition 1.

### Preparation Example 2

### Preparation of Base Coating Composition 2

A thermosetting acryl resin manufactured by Nippon Paint Co., Ltd. (having a hydroxyl value of 45 mgKOH/g, an acid value of 15 mgKOH/g, a number average molecular weight of 21000, and a solid content of 50% by weight), a thermosetting polyester resin manufactured by Nippon Paint Co., Ltd. (having a hydroxyl value of 110 mgKOH/g, an acid value of 8 mgKOH/g, a number average molecular weight of 2700, a weight average molecular weight of 16000, and a solid content of 60% by weight) and U-VAN 20N60 (which was a butyl-etherified melamine resin, manufactured by Mitsui Toatsu Chemicals Inc., having a solid content of 60%) were charged into a stainless beaker [in a weight ratio of 60/15/25 (acryl resin/polyester resin/melamine resin) as a basis of solid content]. Coloring pigments: CYANINE BLUE G-314 (which was an organic blue pigment manufactured by Sanyo Shikiso K. K. [PWC=6.5%]) and Hostaperm Violet BL (which was an organic violet pigment manufactured by Clariant Inc. [PWC=1.4%]); and luster color pigments: ALUMINUM PASTE 65-388 (which was an aluminum luster color pigment manufactured by Toyo Aluminum K. K. [PWC=1.6%]) and XIRALLIC T60-23WNT (which was an interference alumina luster color pigment manufactured by Merck & Co., Inc. [PWC=6.9%]); and then 8% by weight of crosslinked resin particles (which was a viscosity control agent, manufactured by Nippon Paint Co., Ltd., having an average particle size of 55 nm and a solid content of 20%), and 0.8% by weight of a surface conditioning agent of an acryl resin, relative to solid resin content, were further added thereto and mixed to give a base coating composition 2.

### Preparation Example 3

### Preparation of First Clear Coating Composition 1

### Preparation Example 3-1

### Synthesis of Acryl Resin (A)

70.0 g of Xylene and 30.0 g of n-butanol were charged into a separable flask equipped with a reflux condenser, a dropping funnel, a thermometer and a stirring blade. The mixture was heated to 120° C. under a nitrogen atmosphere. A monomer mixed solution of 35.0 parts of styrene, 14.5 parts of n-butyl acrylate, 38.6 parts of 4-hydroxybutyl acrylate, 10.0 parts of lauryl methacrylate, 1.9 parts of acrylic acid, 7.0 g of Kaya ester-O (manufactured by Kayaku Akzo Corporation, as a radical polymerization initiator) and 10.0 g of xylene was added dropwise through the dropping funnel at a constant rate over 3 hours to the mixture. After the addition, the mixture was kept under the nitrogen atmosphere, with stirring, at the same temperature for 30 minutes. Subsequently, a mixed solution of 10.0 g of xylene and 1.0 g of Kaya ester-O was added dropwise through the dropping funnel at a constant rate over 30 minutes to the mixture. Subsequently, the mixture was kept under the nitrogen atmosphere, with stirring, at the same temperature for 2 hours to give an acryl resin having a hydroxyl value of 150 mgKOH/g, an acid value of 15 mgKOH/g and a number average molecular weight of 3500.

### Preparation Example 3-2

### Synthesis of Acryl Resin (b)

70.0 g of Solvesso 100 (S-100) and 30.0 g of butyl acetate were charged into a separable flask equipped with a reflux condenser, a dropping funnel, a thermometer and a stirring blade. The mixture was heated to 130° C. under a nitrogen atmosphere. A monomer mixed solution of 35.0 parts of styrene, 1.3 parts of n-butyl acrylate, 25.7 parts of 4-hydroxybutyl acrylate, 38.0 parts of glycidyl methacrylate, 8.0 g of Kaya ester-O and 10.0 g of S-100 was added dropwise through the dropping funnel at a constant rate over 3 hours to the mixture. After the addition, the mixture was kept under the nitrogen atmosphere, with stirring, at the same temperature for 30 minutes. Subsequently, a mixed solution of 10.0 g of S-100 and 1.0 g of Kaya ester-O was added dropwise through the dropping funnel at a constant rate over 30 minutes to the mixture. Subsequently, the mixture was kept under the nitrogen atmosphere, with stirring, at the same temperature for 2 hours to give an acryl resin having a hydroxyl value of 100 mgKOH/g, an epoxy equivalent of 374 g/eq and a number average molecular weight of 2500.

### Preparation Example 3-3

### Preparation of First Clear Coating Composition 1

60 Parts of the acryl resin (a), 20 parts of the acryl resin (b), and melamine resins: 10 parts of U-VAN 20N-60 (manufactured by Mitsui Chemicals Inc. [SP value=9.7]) and 10 parts of U-VAN 225 (containing an imino group, manufactured by Mitsui Chemicals Inc. [SP value=9.8]) were weighed in a stainless beaker. Subsequently, a thinner containing Solvesso 100 and ethyl acetate in a weight ratio of 1/1 (Solvesso 100/ethyl acetate) was added to the mixture and stirred in a disper. The thinner was further added to the mixture to give a first clear coating composition 1, wherein the viscosity of the first clear coating composition 1 was adjusted to 20 seconds (at 20° C.) by using a Ford cup (No. 4).

### Preparation Example 4

### Preparation of First Clear Coating Composition 2

“MACFLOW 0-1800 CLEAR” (under a product name, manufactured by Nippon Paint Co., Ltd., which was a clear coating composition, in an acid/epoxy curing system, comprising an anhydride group-containing acryl resin, a carboxyl group-containing polyester resin, and an acryl resin containing a hydroxyl group and an epoxy group) was used as a first clear coating composition 2.

### Preparation Example 5

### Preparation of Second Clear Coating Composition 1

“MACFLOW 0-1800 CLEAR” (under a product name, manufactured by Nippon Paint Co., Ltd.) and coloring pigments: CYANINE BLUE G-314 (which was an organic blue pigment manufactured by Sanyo Shikiso K. K. [PWC=0.2%]) and RAVEN 5000 ULTRA III POWDER (which was a carbon black pigment manufactured by COLUMBIAN CHEMICALS Co., Ltd. [PWC=0.08%]) were mixed and stirred in a stainless beaker. Subsequently, a thinner containing Solvesso 100 and ethyl acetate in a weight ratio of 1/1 (Solvesso 100/ethyl acetate) was added to the mixture to give a second clear coating composition 1, wherein the viscosity of the second clear coating composition 1 was adjusted to 20 seconds (at 20° C.) by using a Ford cup (No. 4).

### Preparation Example 6

### Preparation of Second Clear Coating Composition 2

“MACFLOW 0-1800 CLEAR” (under a product name, manufactured by Nippon Paint Co., Ltd.) and a coloring pigment: CYANINE BLUE G-314 (which was an organic blue pigment manufactured by Sanyo Shikiso K. K. [PWC=0.2%]) were mixed and stirred in a stainless beaker. Subsequently, a thinner containing Solvesso 100 and ethyl acetate in a weight ratio of 1/1 (Solvesso 100/ethyl acetate) was added to the mixture to give a second clear coating composition 2, wherein the viscosity of the second clear coating composition 2 was adjusted to 20 seconds (at 20° C.) by using a Ford cup (No. 4).

### Preparation Example 7

### Preparation of Test Panel

A cationic electrodeposition coating composition “POWERTOP U-80” (manufactured by Nippon Paint Co., Ltd.) was applied on a steel panel which had been treated with zinc phosphate. Subsequently, the panel was baked and dried. An intermediate coating composition “ORGA P-2” (manufactured by Nippon Paint Co., Ltd.) was applied on the panel. Subsequently, the panel was baked and dried to give a test panel for evaluating the following coating procedures.

### Example 1

### Preparation of Multi Layered Coating Film

### First Step:

The base coating composition 1 prepared in the Preparation Example 1 was applied on the test panel prepared in the Preparation Example 7 by spraying in order to form an uncured base coating film 1 so that thickness of the resulting dried base coating film 1 was 15 μm.

### Second Step:

The first clear coating composition 1 prepared in the Preparation Example 3 was applied on the uncured base coating film 1, by wet-on-wet, in order to form an uncured first clear coating film 1 so that thickness of the resulting dried first clear coating film 1 was 25 μm.

### Third Step:

Both of the uncured base coating film 1 and the uncured first clear coating film 1 were subjected to baking and curing at 140° C. for 30 minutes.

### Fourth Step:

The cured first clear coating film 1 was subjected to water-sanding on its surface with sandpaper #1500 to give a smooth surface.

### Fifth Step:

The second clear coating composition 1 prepared in the Preparation Example 5 was applied allover the first clear coating film 1 to form an uncured second clear coating film 1 so that thickness of the resulting dried second clear coating film 1 was 35 μm.

### Sixth Step:

The uncured second clear coating film 1 was subjected to baking and curing at 140° C. for 30 minutes to form a cured second clear coating film 1 in order to give a multi layered coating film.

### Example 2

According to the Example 1, a multi layered coating film was formed in a similar manner to that in the Example 1 with the proviso that the second clear coating composition 2 prepared in the Preparation Example 6 was used instead of the second clear coating composition 1 prepared in the Preparation Example 5 which was used in the fifth step of the Example 1.

### Example 3

According to the Example 1, a multi layered coating film was formed in a similar manner to that in the Example 1 with the proviso that the base coating composition 2 prepared in the Preparation Example 2 was used instead of the base coating composition 1 prepared in the Preparation Example 1 which was used in the first step of the Example 1.

### Example 4

According to the Example 1, a multi layered coating film was formed in a similar manner to that in the Example 1 with the proviso that the base coating composition 2 prepared in the Preparation Example 2 was used instead of the base coating composition 1 prepared in the Preparation Example 1 which was used in the first step of the Example 1, and that the second clear coating composition 2 prepared in the Preparation Example 6 was used instead of the second clear coating composition 1 prepared in the Preparation Example 5 which was used in the fifth step of the Example 1.

### Comparative Example 1

According to the Example 1, a multi layered coating film was formed in a similar manner to that in the Example 1 with the proviso that the third step (i.e., a baking or curing step) and the fourth step (i.e., a sanding or polishing step) in the Example 1 were omitted (i.e., (3C1B)).

### Comparative Example 2

According to the Example 1, a multi layered coating film was formed in a similar manner to that in the Example 1 with the proviso that the second clear coating composition 1 prepared in the Preparation Example 5 (i.e., a colored clear coating composition) was used instead of the first clear coating composition 1 prepared in the Preparation Example 3 which was used in the second step of the Example 1, and that the fourth step (i.e., a sanding or polishing step) was omitted, and further that, the first clear coating composition 2 prepared in the Preparation Example 4 (i.e., a colorless transparent clear coating composition) was used instead of the second clear coating composition 1 prepared in the Preparation Example 5 which was used in the fifth step of the Example 1.

### Comparative Example 3

According to the Example 1, a multi layered coating film was formed in a similar manner to that in the Example 1 with the proviso that the first clear coating composition 2 prepared in the Preparation Example 4 (i.e., a colorless transparent clear coating composition) was used instead of the first clear coating composition 1 prepared in the Preparation Example 3 which was used in the second step of the Example 1, and that the fourth step (i.e., a sanding or polishing step) was omitted, and further that the first clear coating composition 2 prepared in the Preparation Example 4 (i.e., a colorless transparent clear coating composition) was used instead of the second clear coating composition 1 prepared in the Preparation Example 5 which was used in the fifth step of the Example 1.

### Comparative Example 4

According to the Example 1, a multi layered coating film was formed in a similar manner to that in the Example 1 with the proviso that the fourth step (i.e., a sanding or polishing step) was omitted, and that the first clear coating composition 2 prepared in the Preparation Example 4 (i.e., a colorless transparent clear coating composition) was used instead of the second clear coating composition 1 prepared in the Preparation Example 5 which was used in the fifth step of the Example 1.

### Comparative Example 5

According to the Example 1, a multi layered coating film was formed in a similar manner to that in the Example 1 with the proviso that the fourth step (i.e., a sanding or polishing step) was omitted.

### Comparative Example 6

According to the Comparative Example 2, a multi layered coating film was formed in a similar manner to that in the Comparative Example 2 with the proviso that the fourth step (i.e., a sanding or polishing step) was additionally conducted.

The multi layered coating films prepared in the Examples and the Comparative Examples were evaluated according to the following evaluation basis with respect to appearance on smoothness; design properties on transparency, color tone along depth, and jet black color or piano black color property; adhering property without sanding or polishing; and uniformity. The results are shown in the following Tables.

Appearance on Smoothness

Smoothness was visually evaluated in accordance with the following basis.

1: Terrible

2: Bad

3: No good

4: Good

5: Excellent

Transparency

Transparency was visually evaluated in accordance with the following basis.

1: Terrible

2: Bad

3: No good.

4: Good

5: Excellent

Color Tone Along Depth

Color tone along depth (i.e., color tone of the coating film in its depth) was visually evaluated in accordance with the following basis.

1: Terrible

2: Bad

3: No good

4: Good

5: Excellent

Jet Black Color or Piano Black Color Property

Jet black color or piano black color property was visually evaluated in accordance with the following basis.

1: Terrible

2: Bad

3: No good

4: Good

5: Excellent

Adhering Property without Sanding or Polishing

Adhering property without sanding or polishing was evaluated based on the results from the following test on cross-hatched coating film.
Cross-cut adhesion test (on a coating film resulted from 3C2B including baking at 160° C. for 60 minutes and baking at 120° C. for 30 minutes)

The base coating composition for the Example or the Comparative Example was applied on the test panel prepared in the Preparation Example 7 by air-spraying with an electrostatic spraying machine: Auto REA (manufactured by Ransburg Industrial Finishing K. K., Gema Division) at an atomization pressure of 5 kg/cm² so that thickness of the resulting dried base coating film was about 16 μm. Setting was placed for about one minute. The panel was subjected to preheating at 80° C. for 5 minutes.

Subsequently, the first clear coating composition having a viscosity previously adjusted to 20 seconds (at 20° C.) with a Ford cup (No. 4) was applied thereon so that thickness of the resulting dried first clear coating film was about 40 μm. Setting was placed for about 7 minutes. The panel was subjected to baking at 160° C. for 60 minutes.

After the baking, the panel was allowed to be left in a desiccator for 30 minutes, and then taken up. The second clear coating composition having a viscosity previously adjusted to 20 seconds (at 20° C.) with a Ford cup (No. 4) was immediately applied on the first clear coating film by spraying so that thickness of the resulting dried second clear coating film was about 40 μm. Setting was placed for about 7 minutes. Subsequently, the panel was baked at 120° C. for 30 minute to give a testing specimen.

Thus prepared testing specimen was subjected to cross-cut with squares (in 2 mm×2 mm). The cross-cut was carried our by using a cutter knife: NT cutter (under a product name) in S-type, A-type, or an equivalent thereof. The cutter blade was forced to allow cross-cut on the coated surface of the specimen at an angle of about 30 degree, and then the cutter blade was reached to the substrate. An adhesive tape: cellophane tape (manufactured by Nichiban Co., Ltd.) was uniformly adhered on the cross-cut surface of the specimen with pressuring with a finger to prevent from forming air-blisters. Immediately after that, the adhesive tape was vigorously peeled off, from one end to the other end, with keeping an angle of the peeled tape at 90 degree to the coated surface of the specimen. The number of the cross-cut coating squares remained on the substrate of the specimen was counted. The number is meant, within a range of from 0 to 100, an index of adhering property without sanding or polishing.

Unevenness

Unevenness was evaluated according to the following evaluation basis.

◯: Excellent

X: Terrible

TABLE 1

| | | | Examples | | | |
|---|---|---|---|---|---|---|
| | | | 1 | 2 | 3 | 4 |
| Step | 1 | Base coating | Prep. | Prep. | Prep. | Prep. |
| | | composition | Ex. 1 | Ex. 1 | Ex. 2 | Ex. 2 |
| | 2 | Clear coating | Prep. | Prep. | Prep. | Prep. |
| | | composition | Ex. 3 | Ex. 3 | Ex. 3 | Ex. 3 |
| | 3 | Baking or | ◯ | ◯ | ◯ | ◯ |
| | | Curing | (Yes) | (Yes) | (Yes) | (Yes) |
| | 4 | Sanding or | ◯ | ◯ | ◯ | ◯ |
| | | Polishing | (Yes) | (Yes) | (Yes) | (Yes) |
| | 5 | Clear coating | Prep. | Prep. | Prep. | Prep. |
| | | composition | Ex. 5 | Ex. 6 | Ex. 5 | Ex. 6 |
| | 6 | Baking or | ◯ | ◯ | ◯ | ◯ |
| | | Curing | (Yes) | (Yes) | (Yes) | (Yes) |

| | | | | | |
|---|---|---|---|---|---|
| Evaluation | Smoothness | 5 | 5 | 5 | 5 |
| | Transparency | 5 | 5 | 5 | 5 |
| | Color tone | 5 | 5 | 5 | 5 |
| | along depth | | | | |
| | Jet black color or | 5 | 4 | 5 | 4 |
| | Piano black color | | | | |
| | property | | | | |
| | Adhering property | 100 | 100 | 100 | 100 |
| | without sanding or | | | | |
| | polishing | | | | |
| | Unevenness | ◯ | ◯ | ◯ | ◯ |

TABLE 2

| | | | Comparative Examples | | | | | |
|---|---|---|---|---|---|---|---|---|
| | | | 1 | 2 | 3 | 4 | 5 | 6 |
| Step | 1 | Base coating | Prep. | Prep. | Prep. | Prep. | Prep. | Prep. |
| | | composition | Ex. 1 | Ex. 1 | Ex. 1 | Ex. 1 | Ex. 1 | Ex. 1 |
| | 2 | Clear coating | Prep. | Prep. | Prep. | Prep. | Prep. | Prep. |
| | | composition | Ex. 3 | Ex. 5 | Ex. 4 | Ex. 3 | Ex. 3 | Ex. 5 |
| | 3 | Baking or | — | ◯ | ◯ | ◯ | ◯ | ◯ |
| | | Curing | (No) | (Yes) | (Yes) | (Yes) | (Yes) | (Yes) |
| | 4 | Sanding or | — | — | — | — | — | ◯ |
| | | Polishing | (No) | (No) | (No) | (No) | (No) | (Yes) |
| | 5 | Clear coating | Prep. | Prep. | Prep. | Prep. | Prep. | Prep. |
| | | composition | Ex. 5 | Ex. 4 | Ex. 4 | Ex. 4 | Ex. 5 | Ex. 4 |
| | 6 | Baking or | ◯ | ◯ | ◯ | ◯ | ◯ | ◯ |
| | | Curing | (Yes) | (Yes) | (Yes) | (Yes) | (Yes) | (Yes) |

| | | | | | | | |
|---|---|---|---|---|---|---|---|
| Evaluation | Smoothness | 4 | 3 | 3 | 4 | 4 | 4 |
| | Transparency | 4 | 4 | 4 | 4 | 4 | 4 |
| | Color tone | 4 | 4 | 3 | 3 | 4 | 4 |
| | along depth | | | | | | |
| | Jet black color or | 4 | 4 | 3 | 3 | 5 | 4 |
| | Piano black color | | | | | | |
| | property | | | | | | |
| | Adhering | 100 | 70 | 90 | 100 | 100 | 90 |
| | property without | | | | | | |
| | sanding or | | | | | | |
| | polishing | | | | | | |
| | Unevenness | ◯ | ◯ | ◯ | ◯ | ◯ | X |

The multi layered coating films of the Examples 1 to 4 can provide an excellent smoothness, an excellent transparency, and an excellent color tone along its depth, each of which multi layered coating films includes a colorless transparent clear layer as a first clear coating film and a colored clear layer as a second clear coating film, wherein the second clear coating film is provided on the partially sanded or polished first colorless transparent clear coating film. According to the Examples 1 and 3, the base coating film and/or the second clear coating film contains carbon black. Therefore, an excellent jet black color or piano black color property can be provided. Whereas, the Comparative Examples 1 to 5 excludes any sanding or polishing step. Therefore, the smoothness, transparency, and color tone along depth are deteriorated. According to the Comparative Example 6, the colored clear layer formed in the second step is sanded or polished in the fourth step, and then, in the fifth step, the colorless transparent clear layer is formed thereon. As a result, according to the Comparative Example 6, the sanding or polishing of the colored clear layer alters thickness of the colored clear layer to provide unevenness in color. Accordingly, light past through the colorless transparent clear layer is reflected and diffracted on the sanded or polished surface to provide a different hue from the original hue. Therefore, the Comparative Example 6 can not provide any excellent smoothness, transparency, color tone along depth, and jet black color or piano black color property in comparison with the Examples 1 to 4 according to the present invention, although the Comparative Example 6 provides improved smoothness in comparison with the Comparative Example 2 excluding any sanding or polishing step.

### INDUSTRIAL APPLICABILITY

The method according to the present invention can provide a multi layered coating film having an excellent appearance (e.g., smoothness), comparable to the conventional 4C2B method, and design properties (e.g., transparency, color tone in its depth). The method according to the present invention has a superior convenience to that of the conventional 4C2B method.

Furthermore, the method according to the present invention, which can provide excellent transparency and color tone in its depth, is particularly suitable for coating in a dark color. In addition, the method according to the present invention can provide an excellent jet black color or piano black color property. Therefore, the method according to the present invention has significant benefits particularly in coating a specific article to be coated such as a luxury car.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising”, “having”, “including”, and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those skilled in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for producing a multi layered coating film, which comprises steps of:
applying a base coating composition comprising a luster color pigment and a coloring pigment on an article to form a base coating;
applying a first clear coating composition, on the base coating, to form a first clear coating thereon;
subjecting both of the base coating and the first clear coating thereon to baking and/or curing to form a cured base coating film and a cured first clear coating film thereon;
sanding or polishing at least one part of the cured first clear coating film to form a partially sanded or polished first clear coating film;
applying a second clear coating composition allover the first clear coating film to form a second clear coating; and
subjecting the second clear coating to baking and/or curing to form a cured second clear coating film;
wherein
the first clear coating composition comprises no coloring pigment, and
the second clear coating composition comprises a coloring pigment, wherein concentration of the coloring pigment in the second clear coating composition (PWC) is within a range of from 0.001 to 0.8%.

2. The method according to claim 1, wherein the coloring pigment in the base coating composition includes carbon black.

3. The method according to claim 1, wherein the coloring pigment in the second clear coating composition includes carbon black.

4. A multi layered coating film obtained/obtainable by the method according to claim 1.

5. The method according to claim 2, wherein the coloring pigment in the second clear coating composition includes carbon black.

6. A multi layered coating film obtained/obtainable by the method according to claim 2.

7. A multi layered coating film obtained/obtainable by the method according to claim 3.

8. A multi layered coating film obtained/obtainable by the method according to claim 5.
